(19) United States
(12) Patent Application Publication
(10) Pub. No.: US 2014/0141310 A1
(43) Pub. Date: May 22, 2014

(54) BATTERY FASTENING DEVICE FOR A SEAT TUBE OF A BICYCLE

(71) Applicant: Mu-Rong Li, Taichung City (TW)

(72) Inventor: Mu-Rong Li, Taichung City (TW)

(21) Appl. No.: 13/684,161

(22) Filed: Nov. 22, 2012

(51) Int. Cl. H01M 2/10

(52) U.S. Cl. CPC H01M 2/10
USPC 429/100

(57) ABSTRACT

A battery fastening device for a seat tube of a bicycle includes a tube member, a cap member and a cover member, the tube member having a receiving channel, the cap member having an assembling portion, one end of the assembling portion assembled to the tube member, another end of the cap member having a handling block, the handling block exposed out from the seat tube, the cap member having a passage which communicating with the receiving channel, the battery assembly received into the receiving channel, the battery assembly attached to the passage, the cover member defined between the seat tube and the tube member and sleeving on the tube member tightly. Under this arrangement, the tube member is tightly positioned in the seat tube because of the cover member, so that the battery assembly is stably positioned within the seat tube.

### BACKGROUND OF THE INVENTION

1. Field of the Invention

The present invention relates to a battery fastening device, and more particularly to a battery fastening device for a seat tube of a bicycle.

2. Description of Related Art

A conventional bicycle tubing for receiving battery assembly comprises a tubing assembly, a battery assembly and a enclosing member, the tubing assembly having a middle tube defined therein, the middle tube having a receiving room defined therein so as to receive the battery assembly, the middle tube having an opening formed at a top end thereof, the enclosing member enclosing the opening. Under this arrangement, a user put the battery assembly into the receiving room of the middle tube of the tubing assembly so as to fasten the battery assembly on a bicycle.

However, the conventional bicycle tubing for receiving battery assembly has one disadvantage as following.

In order to position the battery assembly within the middle tube, the middle tube further comprises a fastening means which could be accomplished via a C-shaped clamp or a glue material; while when the user needs to change the battery assembly, the user has to remove the fastening means firstly; as a result, the user might damage the bicycle tubing and the battery assembly.

The present invention has arisen to mitigate and/or obviate the disadvantages of the conventional.

### SUMMARY OF THE INVENTION

The main objective of the present invention is to provide a battery fastening device.

To achieve the objective, battery fastening device for a seat tube of a bicycle comprises a tube member, a cap member and a cover member, the tube member having a receiving channel opened therethrough, the cap member having an assembling portion defined at one end thereof, one end of the assembling portion assembled to the tube member, another end of the cap member having a handling block extruded therefrom, the handling block exposed out from the seat tube, the cap member having a passage opened through the assembling portion and the handling block, the passage communicating with the receiving channel, the battery assembly received into the receiving channel, a positive terminal of the battery assembly attached to the passage, the cover member defined between the seat tube and the tube member and sleeving on an outer periphery of the tube member tightly. Wherein, the tube member further comprises a first protrusion, a second protrusion and a neck portion; one end of the neck portion is connected to the first protrusion, and another end of the neck portion is connected to the second protrusion; the cover member sleeves on the neck portion of the tube member tightly and is positioned between the first protrusion and the second protrusion of the tube member; a diameter of the neck portion is gradually increased from one end thereof toward another end thereof; a first diameter of the first protrusion and a second diameter of the second protrusion are both larger than the diameter of the neck portion; the receiving channel of the tube member has a first threaded portion defined at one end of an inner wall thereof; the assembling portion of the cap member has a second threaded portion defined at an outer periphery thereof; the first threaded portion threads with the second threaded portion; the passage of the cap member has an annular flange extruded from an inner wall thereof for abutting against and positioning the battery assembly; the cover member is made of foam materials.

Under this arrangement, the tube member is tightly positioned in the seat tube because of the cover member, so that the battery assembly is stably positioned within the seat tube; in addition, when the cap member is departed from the tube member, a user changes the battery assembly easily and conveniently.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a battery fastening device for a seat tube of a bicycle of the present invention;

FIG. 2 is an exploded view for showing a relationship between the present invention, a battery assembly and a seat tube;

FIG. 3 is an exploded view of the battery fastening device for a seat tube of a bicycle;

FIG. 4 is a perspective view for showing the present invention is assembled to the seat tube; and

FIG. 5 is a cross-sectional view along line 5-5 shown in FIG. 4.

### DETAILED DESCRIPTION OF THE INVENTION

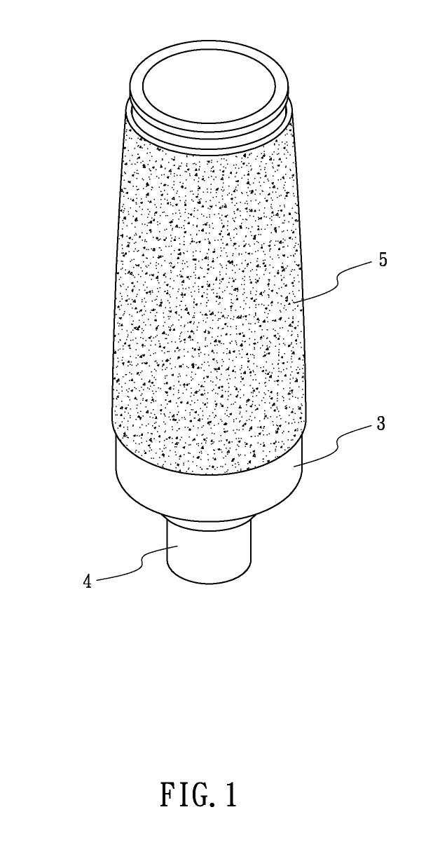

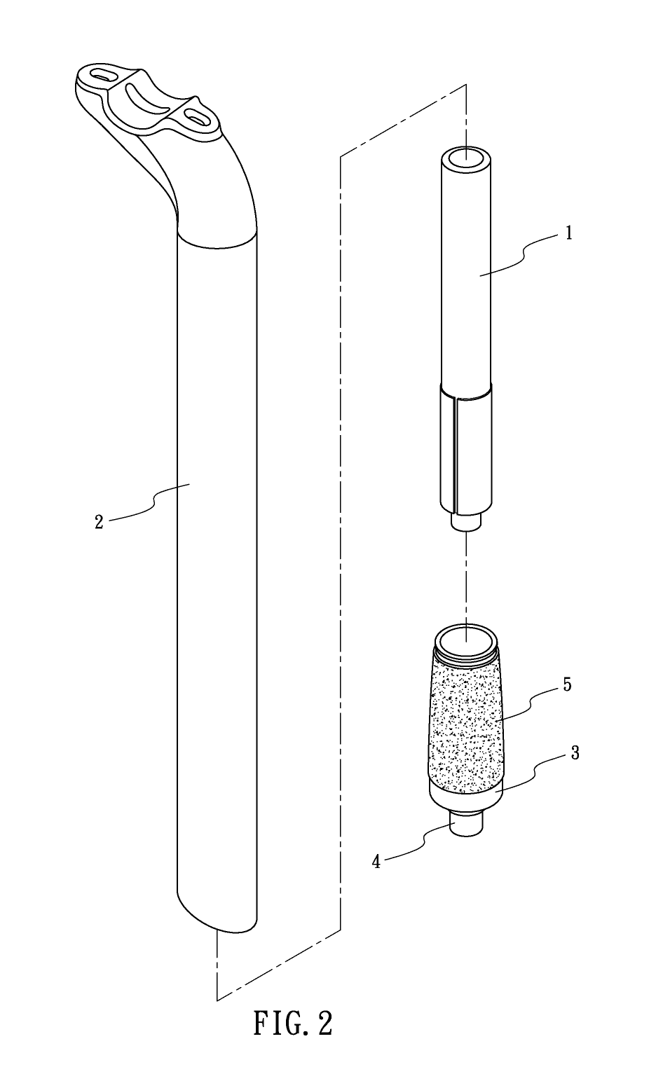

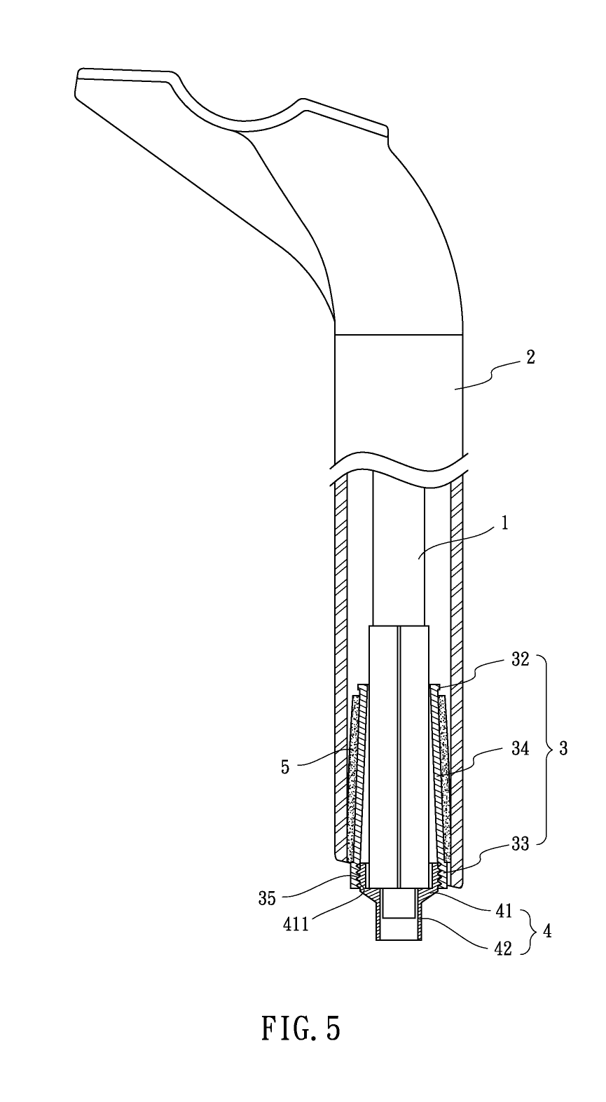

Referring to FIGS. 1-5, a battery fastening device for a seat tube of a bicycle in accordance with the present invention which fastens a battery assembly 1 within a seat tube 2 comprises a tube member 3, a cap member 4 and a cover member 5.

The tube member 3 has a receiving channel 31 opened therethrough.

The cap member 4 has an assembling portion 41 defined at one end thereof. One end of the assembling portion 41 is assembled to the tube member 3. Another end of the cap member 4 has a handling block 42 extruded therefrom. The handling block 42 is exposed out from the seat tube 2. The cap member 4 has a passage 43 opened through the assembling portion 41 and the handling block 42. The passage 43 communicates with the receiving channel 31. The battery assembly 1 is received into the receiving channel 31. A positive terminal (not numbered) of the battery assembly 1 is attached to the passage 43.

The cover member 5 is defined between the seat tube 2 and the tube member 3 and sleeves on an outer periphery of the tube member 2 tightly.

Under this arrangement, the tube member 3 is tightly positioned in the seat tube 2 because of the cover member 5, so that the battery assembly 1 is stably positioned within the seat tube 2; in addition, when the cap member 4 is departed from the tube member 3, a user changes the battery assembly 1 easily and conveniently.

Referring to FIGS. 1-5, because of the cover member 5 which is elastic and the friction between the cover member 5 and an inner wall of the seat tube 2, the tube member 3 is positioned within the seat tube 2, so that the battery assembly 1 is well fastened in the seat tube 2. In a preferred embodiment, the cover member 5 is made of foam materials which have a higher friction with metals and are insulated, so that the user does not suffer electric shock even if the electricity unexpectedly leak out from the battery assembly 1 (The material of the cover member 5 is not limited in the present invention.).

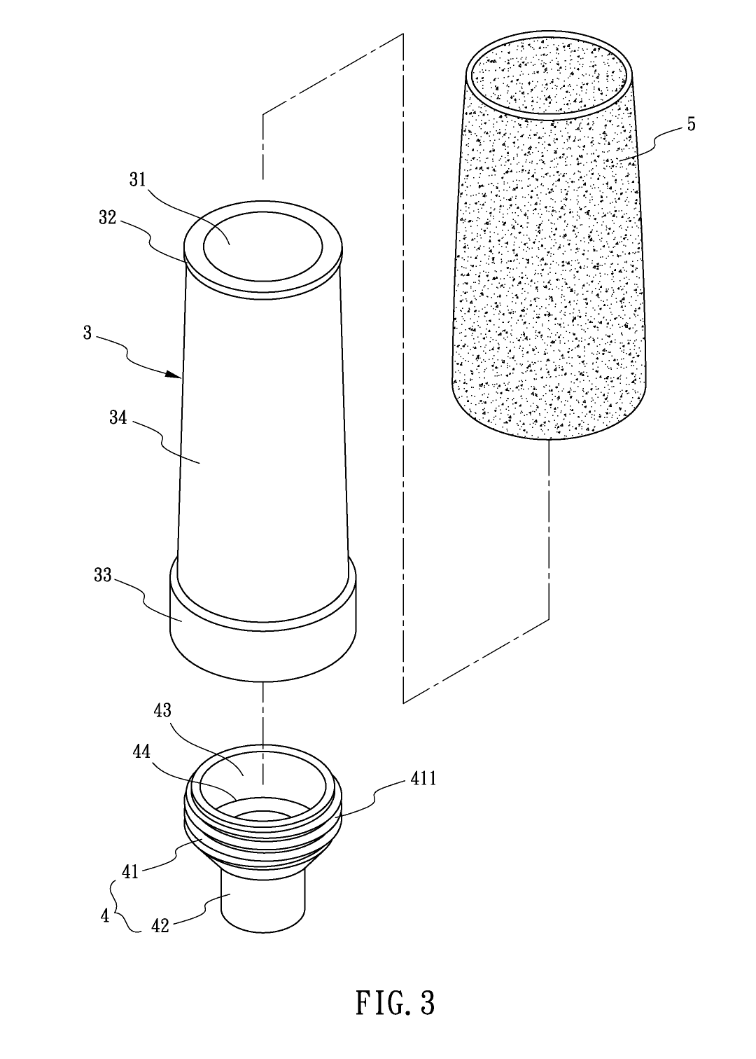

Referring to FIG. 3, the tube member 3 further comprises a first protrusion 32, a second protrusion 33 and a neck portion 34. One end of the neck portion 34 is connected to the first protrusion 32, and another end of the neck portion 34 is connected to the second protrusion 33. A diameter of the neck portion 34 is gradually increased from one end thereof toward another end thereof. A first diameter of the first protrusion 32 and a second diameter of the second protrusion 33 are both larger than the diameter of the neck portion 34. The cover member 5 sleeves on the neck portion 34 of the tube member 3 tightly and is positioned between the first protrusion 32 and the second protrusion 33 of the tube member 3. Therefore, the user inserts the first protrusion 32 of the tube member 3 into the seat tube 2, so that the tube member 3 is fastened within the seat tube 2 because of the shape of the neck portion 34 and the friction between the cover member 5 and the inner wall of the seat tube 2.

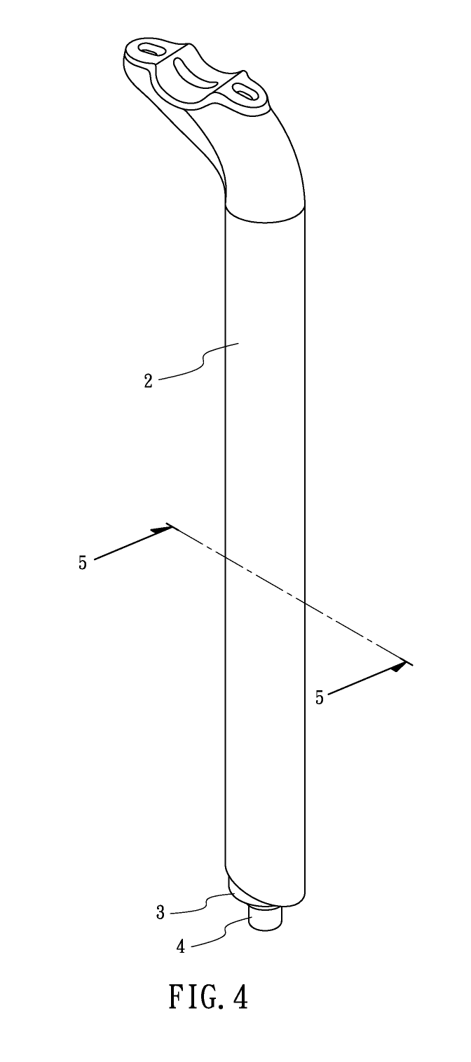

Referring to FIG. 4, the passage 43 of the cap member 4 has an annular flange 44 extruded from an inner wall thereof. The positive terminal of the battery assembly 1 is inserted into another end of the receiving channel 31 and moved toward one end of the receiving channel 31 until the positive terminal of the battery assembly 1 is abutted against and positioned by the annular flange 44 of the cap member 4. Therefore, the user electrically connects wires of electric devices (not shown) on the bicycle (not shown) with the battery assembly 1 from another end of the cap member 4 so as to actuate the electric devices. Consequently, the battery assembly 1 does not fall from the cap member 4 because of the annular flange 44.

Referring to FIG. 3 and FIG. 4, the tube member 3 is assembled to the cap member 4 via a fastening means so that the user departs the cap member 4 and the battery assembly 1 from the seat tube 2. In a preferred embodiment, the receiving channel 31 of the tube member 3 has a first threaded portion 35 defined at one end of an inner wall thereof. The assembling portion 41 of the cap member 4 has a second threaded portion 411 defined at an outer periphery thereof. The first threaded portion 35 threads with the second threaded portion 411. Under this arrangement, the cap member 4 is assembled to the tube member 3 compactly so that the user changes the battery assembly 1 easily and conveniently (The fastening means is not limited in the present invention.).

All in all, the present invention has three advantages described as following.

Firstly, the user does not suffer electric shock when the electricity unexpectedly leak out from the battery assembly 1 because the cover member 5 is made of foam and is electrically insulated.

Secondly, because the handling block 42 of the cap member 4 is exposed out of the seat tube 2, the user holds the handling block 42 so as to depart the cap member 4 from the seat tube 2, so that the user changes the battery assembly 1 easily and conveniently without damaging the seat tube 2 and the elements of the present invention.

Thirdly, the tube member 3 is positioned within the seat tube 2 stably because of the friction between the cover member 5 and the seat tube 2, so that the battery assembly 1 is stably positioned within the seat tube 2.

Although the invention has been explained in relation to its preferred embodiment, it is to be understood that many other possible modifications and variations can be made without departing from the spirit and scope of the invention as hereinafter claimed.

What is claimed is:

1. A battery fastening device for a seat tube of a bicycle comprising:
a tube member, a cap member and a cover member;
the tube member having a receiving channel opened therethrough;
the cap member having an assembling portion defined at one end thereof, one end of the assembling portion assembled to the tube member, another end of the cap member having a handling block extruded therefrom, the handling block exposed out from the seat tube, the cap member having a passage opened through the assembling portion and the handling block, the passage communicating with the receiving channel, the battery assembly received into the receiving channel, a positive terminal of the battery assembly attached to the passage; and
the cover member defined between the seat tube and the tube member and sleeving on an outer periphery of the tube member tightly;
wherein the tube member is tightly positioned in the seat tube because of the cover member, so that the battery assembly is stably positioned within the seat tube; in addition, when the cap member is departed from the tube member, a user changes the battery assembly easily and conveniently.

2. The battery fastening device for a seat tube of a bicycle as claimed in claim 1, wherein the tube member further comprises a first protrusion, a second protrusion and a neck portion; one end of the neck portion is connected to the first protrusion, and another end of the neck portion is connected to the second protrusion; the cover member sleeves on the neck portion of the tube member tightly and is positioned between the first protrusion and the second protrusion of the tube member.

3. The battery fastening device for a seat tube of a bicycle as claimed in claim 2, wherein a diameter of the neck portion is gradually increased from one end thereof toward another end thereof; a first diameter of the first protrusion and a second diameter of the second protrusion are both larger than the diameter of the neck portion.

4. The battery fastening device for a seat tube of a bicycle as claimed in claim 1, wherein the receiving channel of the tube member has first threaded portion defined at one end of an inner wall thereof; the assembling portion of the cap member has a second threaded portion defined at an outer periphery thereof; the first threaded portion threads with the second threaded portion.

5. The battery fastening device for a seat tube of a bicycle as claimed in claim 1, wherein the passage of the cap member has an annular flange extruded from an inner wall thereof for abutting against and positioning the battery assembly.

6. The battery fastening device for a seat tube of a bicycle as claimed in claim 1, wherein the cover member is made of foam materials.
